(19) United States
(12) Patent Application Publication
(10) Pub. No.: US 2007/0138373 A1
(43) Pub. Date: Jun. 21, 2007

(54) Lead terminal leadout type electronic component, manufacturing method therefor and electronic equipment

(75) Inventor: Hiroshi Yoshida, Hashimoto-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/604,839

(22) Filed: Nov. 28, 2006

(30) Foreign Application Priority Data
Dec. 19, 2005 (JP) P2005-364765

(51) Int. Cl. G01J 1/32

(52) U.S. Cl. 250/205

(57) ABSTRACT

The lead terminal leadout type electronic component of the present invention has a component main body and a plurality of lead terminals led out of the component main body and is mounted on a mount board in a floating state in which the lead terminals are inserted into corresponding insertion holes of the mount board partway along lengths thereof. At least two lead terminals of the plurality of lead terminals are more largely deformed than opening dimensions of the corresponding insertion holes mutually oppositely in a direction along a surface of the mount board in a natural state. When the plurality of lead terminals are inserted into the corresponding insertion holes, the electronic component stands upright with respect to the mount board due to spring forces of said at least two lead terminals which is going to return to the natural state.

### CROSS-REFERENCE TO RELATED APPLICATIONS

This Nonprovisional application claims priority under 35 U.S.C. §119(a) on Patent Application No. 2005-364765 filed in Japan on Dec. 19, 2005, the entire contents of which are hereby incorporated by reference.

### BACKGROUND OF THE INVENTION

The present invention relates to a lead terminal leadout type electronic component adopted for an infrared ray remote control photodetection unit, an infrared communication device (IrDA) and the like used for household electric appliances and information communication products and a manufacturing method therefor. The present invention further relates to electronic equipment equipped with such a lead terminal leadout type electronic component.

In general, electronic equipment called a remote control device transmits an infrared ray optical signal from a remote controller (hereinafter referred to as a remote control transmitter) and receives the infrared ray optical signal by a photodiode (hereinafter referred to as PD) in a remote control receiver (hereinafter referred to as a remote control photodetection unit). The equipment carries out signal amplification, waveform shaping and so on in an internally provided preamplifier IC and generates a signal to be supplied to a control section of the equipment through a conversion into a digital signal. The generated digital signal is transferred as a control signal from an output section of the remote control photodetection unit to the control section of each equipment of a household electric appliance or the like to carry out various sorts of controls.

When the infrared ray optical signal is applied to the PD, a corresponding faint current is generated. The preamplifier IC that receives the current amplifies the current by several tens of thousands of times in an amplifier circuit, and a signal in a necessary frequency band is extracted by a filter circuit (bandpass filter BPF) and subjected to digital signal demodulation similar to that of the transmission signal by a detection circuit.

A brief explanation of the assembling process of the remote control photodetection unit is as follows. Referring to FIG. 5, a metal lead frame 16 is formed by press working from one metal plate so that a plurality of remote control photodetection units can be produced. A PD chip 17 and a preamplifier IC chip 19 are bonded to a die bonding region formed in a broad area of a metal lead frame 16 (made of iron in the mainstream and hereinafter referred to as a lead frame) with an insulative adhesive 18 and a conductive adhesive 20, respectively. The PD chip 17 normally has a PN structure, and an electrical potential is generated in an N-type electrode portion located on the back side of the PD chip 17 since a reverse voltage is applied in the case of the remote control photodetection unit. Therefore, it is necessary to keep an insulative state between the N-type electrode portion of the PD chip 17 and a portion the metal lead frame 16 on which the PD chip 17 is mounted, which is to have a GND potential in terms of the structure. They are bonded together with an epoxy resin that contains an insulative filler for the bonding. The back surface of the preamplifier IC chip 19 has no relation to the signal processing (signal processing is carried out on the surface), and the bonding to the lead frame 16 may be performed with either the conductive adhesive or the insulative adhesive. Normally, the conductive adhesive 20 (adhesive of a mixture of an Ag powder and epoxy resin) excellent both in workability and adhesive property is used. Electrode portions 21 of the PD chip 17 and the preamplifier IC chip 19 are connected to an I/O lead terminal 23 of the lead frame 16 via a gold wire 22 (hereinafter referred to as an Au wire) of a diameter of several tens of micrometers by a wire bonding step. As shown in FIG. 6, the PD chip 17 and the preamplifier IC chip 19 mounted on the metal lead frame 16 are sealed with a thermosetting resin 24 (hereinafter referred to as a mold sealing resin) mixed with a dyestuff that transmits infrared rays and cuts off visible light so that the resin surrounds these chips and thereafter subjected to frame range cutting and deburring. Moreover, the tie bar (indicated by hatching in FIG. 6) of the lead frame 25 exposed from the mold sealing resin portion is cut in order to make the lead terminals electrically independent. Further, a conductive thermoplastic resin 26 (hereinafter referred to as a secondary mold) is formed by injection molding in a secondary molding step to cover the mold sealing resin 24. Subsequently, a soldering step and a single product cutting step are carried out, completing a single remote control photodetection unit as shown in FIGS. 7A through 7E. It is noted that FIGS. 7A through 7E are a left side view, a front view, a right side view, a top view and a bottom view, respectively, of the conventional lead frame type remote control photodetection unit.

In the remote control photodetection unit constructed as described above, the faint current (signal current) generated in the PD is amplified in voltage, and therefore, it is necessary to eliminate external turbulence factors (noises) of electromagnetic noises and so on. If the external turbulence factors (noises) are superimposed on the faint current (signal current) and disadvantageously amplified by the preamplifier IC, it becomes impossible to assure a ratio of the signal to the noises (signal-to-noise ratio), and this consequently causes a failure in signal demodulation in the detection circuit. That is, control by the remote controller becomes impossible. In order to prevent this occurrence, the mold resin portion is sometimes covered with a resin or a metal shield casing according to the purpose of the equipment to be used or the like for the completion of the product.

Moreover, it is necessary to arrange the remote control photodetection unit on the front face of the equipment in order to receive the signal transmitted from the remote control transmitter in the equipment equipped with the remote control photodetection unit. In some television sets and the like, a submount board is arranged separately from the main mount board for driving the equipment, and a remote control photodetection unit is mounted on the submount board and arranged on the front face of the equipment, allowing the signal to be received. It is normally general to mount the unit on the main mount board in consideration of cost.

FIG. 8A shows the front face of equipment equipped with a single remote control photodetection unit such as a television set or a DVD viewed from the front. A signal light receiving window 28 for remote control is provided at an outer frame 27 (mainly a plastic mold) on the front face of the equipment. On the other hand, a remote control photodetection unit 29 is arranged on a main mount board 31 inside the equipment as shown in FIG. 8B (viewed from the right side) and fixed on the main mount board 31 with the height of the remote control photodetection unit 29 adjusted so that a lens position 30 of the remote control photodetection unit 29 is aligned with the position of the signal light receiving window 28.

When the remote control photodetection unit is mounted in a position retreated in depth from the front face of the equipment, it is necessary to efficiently guide the infrared ray optical signal from the front face portion to the photodetection portion of the remote control photodetection unit for the height adjustment, and a remote control photodetection unit provided with a self-supporting shield casing in which the height from the mount board can arbitrarily be set is often used. The remote control photodetection unit provided with the self-supporting shield casing is structurally characterized in that a metal is further extended from the shield casing that covers the resin portion and its end is hooked to the mount board, preventing the leaning thereof. Moreover, in the case of a remote control photodetection unit that has no shield casing (being not the self-supporting type), a method for temporarily fixing the unit with a jig and fixing the same with a solder dip or fixing the unit by engagement with part of another electronic component is adopted. However, such a method disadvantageously causes an increase in the number of manufacturing steps and cost increase.

In contrast to this, JP H05-62002 U discloses an electronic component, in which the leaning of the electronic component in a direction perpendicular to the axial direction of the electronic component is suppressed by providing a bent portion at two leads protrusively in different directions roughly perpendicular to a plane constituted of the leads extending from the component main body, so that the component can be mounted on a printed wiring board in an almost upright state.

However, normally in the mount board, the diameter of a hole through which the component lead terminal is inserted is designed to a size with a margin with respect to the lead terminal size so that the component lead terminal can easily be mounted on the mount board. In the shape described in the first patent document, the component lead terminal, which is straight in portions other than the bent portion, is not mounted in the proper position with respect to the mount board when there is a variation in the diameter of the hole which is formed at the mount board and through which the component lead terminal is inserted even if the lead terminal is inserted into the hole of the mount board elasticity by the bent portion. This causes a trouble that the component is mounted aslant, failing in correctly receiving the signal and causing a significant impairment in the reliability of the equipment.

### SUMMARY OF THE INVENTION

The lead terminal leadout type electronic component mounted on electrical equipment or the like sometimes is required to be a component such that the component main body is mounted floating in a direction of height from a mount board via a component lead terminal and the component produces its function by keeping the height. With regards to the electronic component, the problems of the lack of positional self-supporting property caused by the instability of an engagement relation between the lead terminal and the mount board, which occurs before the former is bonded to the latter by a solder dipping, and a consequent reduction in productivity due to a displacement occurring in the bonding stage should be solved.

In order to solve the problems, a lead terminal leadout type electronic component of the present invention comprises:

a component main body; and

a plurality of lead terminals led out of the component main body, wherein

the electronic component is to be mounted on a mount board in a floating state in which the lead terminals are inserted into corresponding insertion holes of the mount board partway along lengths of the lead terminals, respectively, and

at least two lead terminals of the plurality of lead terminals are more largely deformed than opening dimensions of the corresponding insertion holes mutually oppositely in a direction along a surface of the mount board in a natural state so that, when the plurality of lead terminals are inserted into the corresponding insertion holes, the electronic component stands upright with respect to the mount board due to spring forces of said at least two lead terminals which is going to return to the natural state.

In the lead terminal leadout type electronic component of the present invention, when the plurality of lead terminals are inserted into the respective insertion holes, at least two lead terminals abut against the inner peripheral edges of the insertion holes in mutually opposite directions by the spring forces of the at least two lead terminals which is going to return to the natural state, so that the component stands upright with respect to the mount board, suppressing the leaning. Therefore, the lead terminal leadout type electronic component is mounted on the mount board in an upright state.

In this case, the “natural state” means a state in which no external force is exerted.

It is noted that the lead terminals should desirably be produced by forming a metal plate.

In the lead terminal leadout type electronic component of one embodiment, deformations of said at least two lead terminals in the natural state are comprised of bent portions which are formed mutually oppositely in a back-and-forth direction partway along the length of the lead terminals.

In the lead terminal leadout type electronic component of one embodiment, portions located on a terminal end side with respect to the bent portions of said at least two lead terminals are bent with respect to the bent portions so as to approach the corresponding insertion holes.

In the lead terminal leadout type electronic component of this one embodiment, the plurality of lead terminals are easily inserted into the respective corresponding insertion holes of the mount board.

In the lead terminal leadout type electronic component of one embodiment, the bent portions have an approximate dogleg-like shape, an approximate bracket-like shape or an approximate U-figured shape.

In the lead terminal leadout type electronic component of one embodiment, the bent portions serve as insertion limiting positions of the lead terminals in the insertion holes when the plurality of lead terminals are inserted into the respective corresponding insertion holes.

A lead terminal leadout type electronic component mounting method of the present invention is a method for mounting the lead terminal leadout type electronic component on the mount board in a state in which the lead terminals are inserted in the corresponding insertion holes of the mount board partway along length of each lead terminal, wherein,

by adjusting a distance between the bent portion and the component main body when the bent portion is formed on said at least two lead terminals, a height position of the component main body from the mount board after mounting is variably set.

According to the mounting method of the lead terminal leadout type electronic component of the present invention, the height position of the component main body from the mount board can arbitrarily be set.

In the lead terminal leadout type electronic component of one embodiment, a portion of a width greater than that of a remaining part of each of the lead terminals is provided partway along the length of the lead terminal, and the portion serve as an insertion limiting position of the lead terminal in the insertion hole.

In the lead terminal leadout type electronic component of one embodiment, a portion of a thickness greater than that of a remaining part of each of the lead terminals is provided partway along the length of the lead terminal, and the portion serve as an insertion limiting position of the lead terminal in the insertion hole.

Electronic equipment equipped with the lead terminal leadout type electronic component claimed in claim 1.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1A is a left side view of a lead frame type remote control photodetection unit of one embodiment of the present invention;

FIG. 1B is a front view of the remote control photodetection unit;

FIG. 1C is a bottom view of the remote control photodetection unit;

FIG. 1D is an enlarged view of the lead terminal of FIG. 1A;

FIG. 1E is an enlarged view of the lead terminal of FIG. 1B;

FIG. 1F is an enlarged view of the lead terminal of FIG. 1C;

FIG. 2 is a schematic view showing the lead frame type remote control photodetection unit of the present invention mounted on a mount board;

FIGS. 3A through 3C are schematic views showing various embodiments of the present invention;

FIGS. 4A through 4C are schematic views showing further various embodiments of the present invention;

FIG. 5 is a view (after a wire bonding step) showing the structure of a general lead frame type remote control photodetection unit;

FIG. 6 is a view (after a packaging step) showing the structure of the general lead frame type remote control photodetection unit;

FIGS. 7A through 7E are a left side view, a front view, a right side view, a top view and a bottom view, respectively, of a prior art lead frame type remote control photodetection unit;

FIG. 8A is a view showing the front face of general equipment equipped with a remote control photodetection unit viewed from the front; and

FIG. 8B is a view showing the inside of the equipment viewed from the right side.

### DETAILED DESCRIPTION OF THE PREFERRED EMBODIMENTS

### The First Embodiment

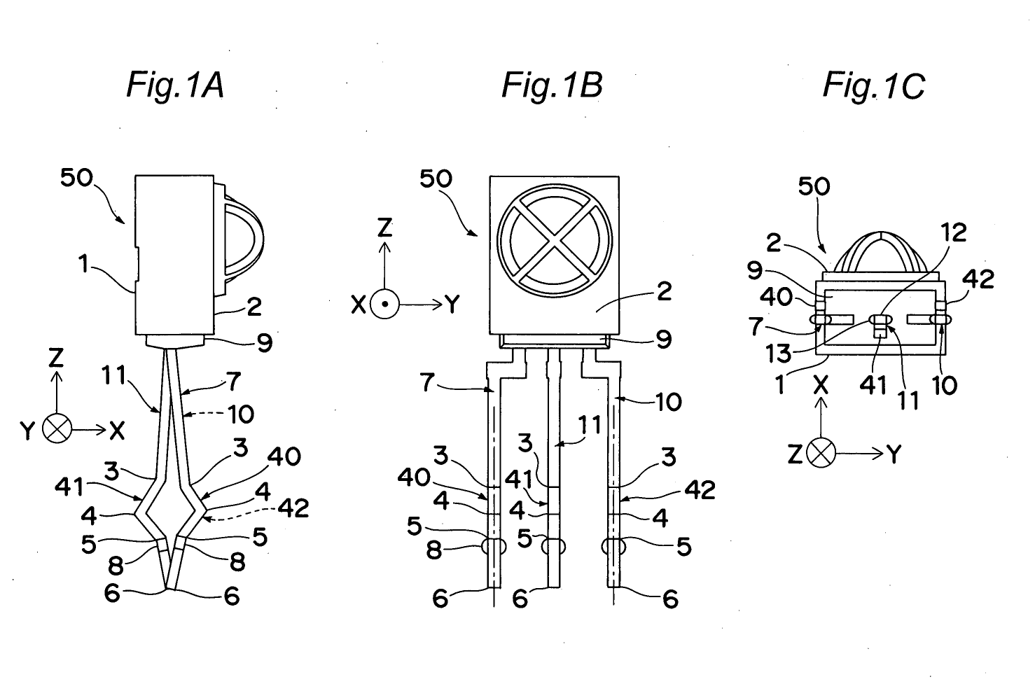

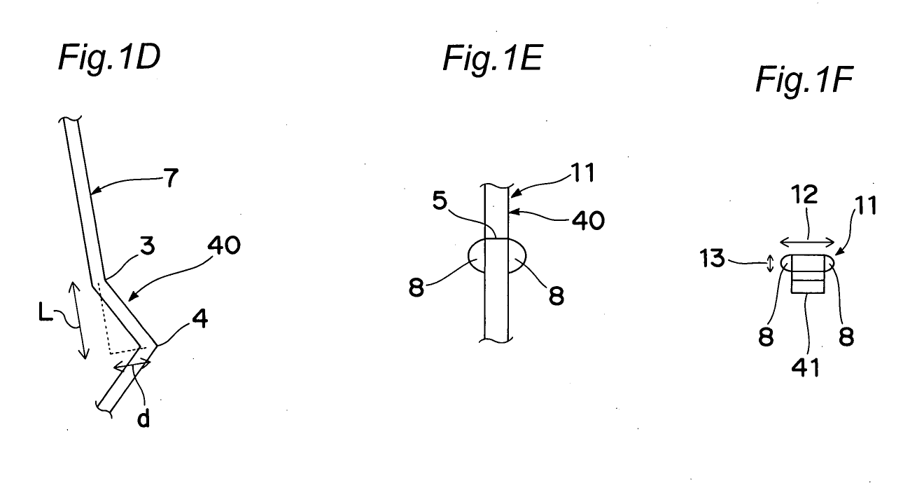

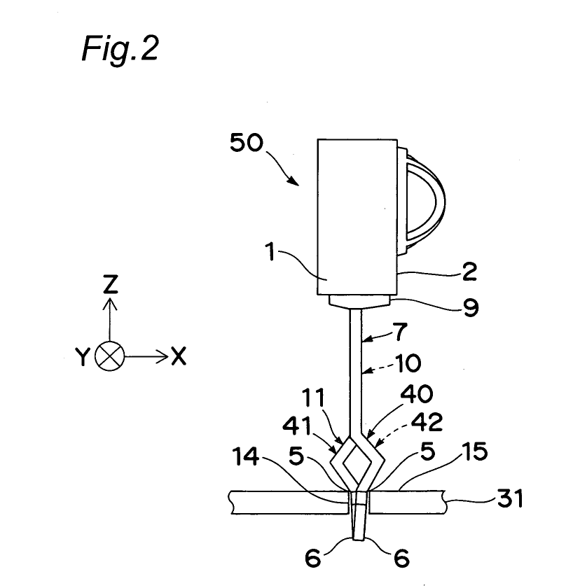

FIGS. 1A through 1C are schematic views showing a remote control photodetection unit 50 in a natural state as a lead terminal leadout type electronic component relevant to the first embodiment of the present invention. FIG. 1A is a left side view of the remote control photodetection unit 50, FIG. 1B is a front view of the remote control photodetection unit 50, and FIG. 1C is a bottom view of the remote control photodetection unit 50. FIG. 2 is a schematic view of the remote control photodetection unit 50 mounted on a mount board 31.

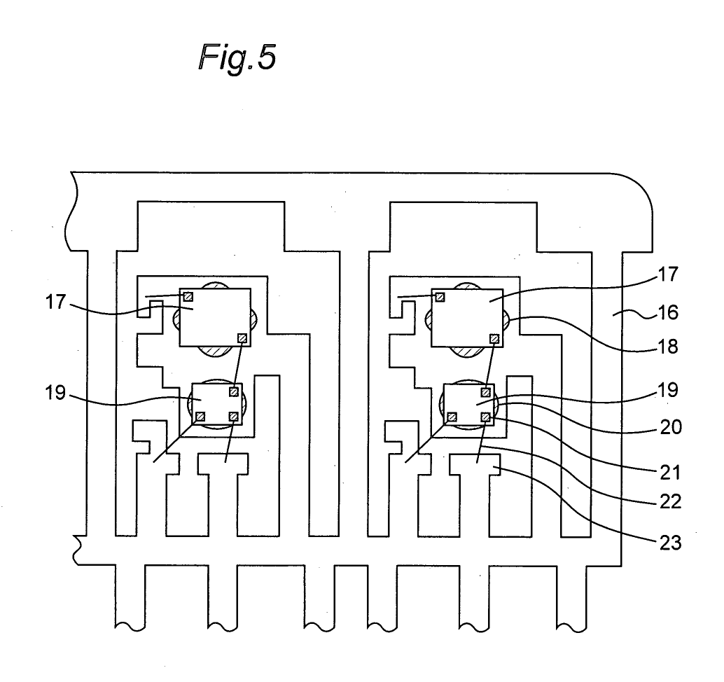

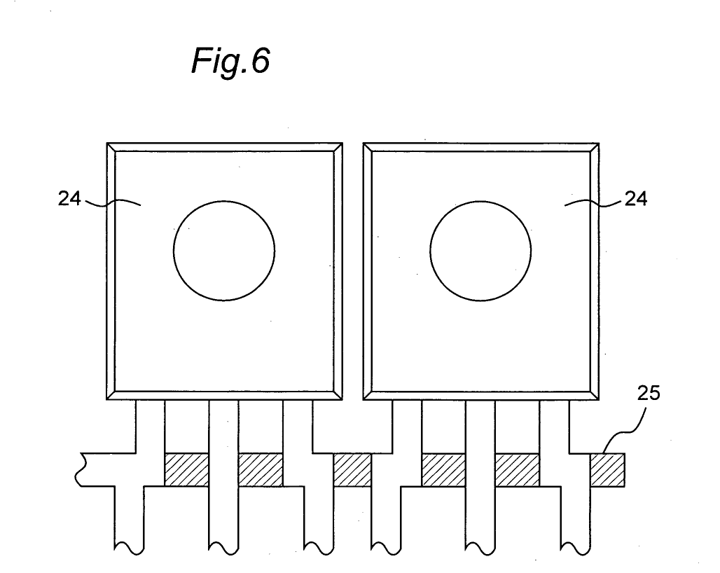

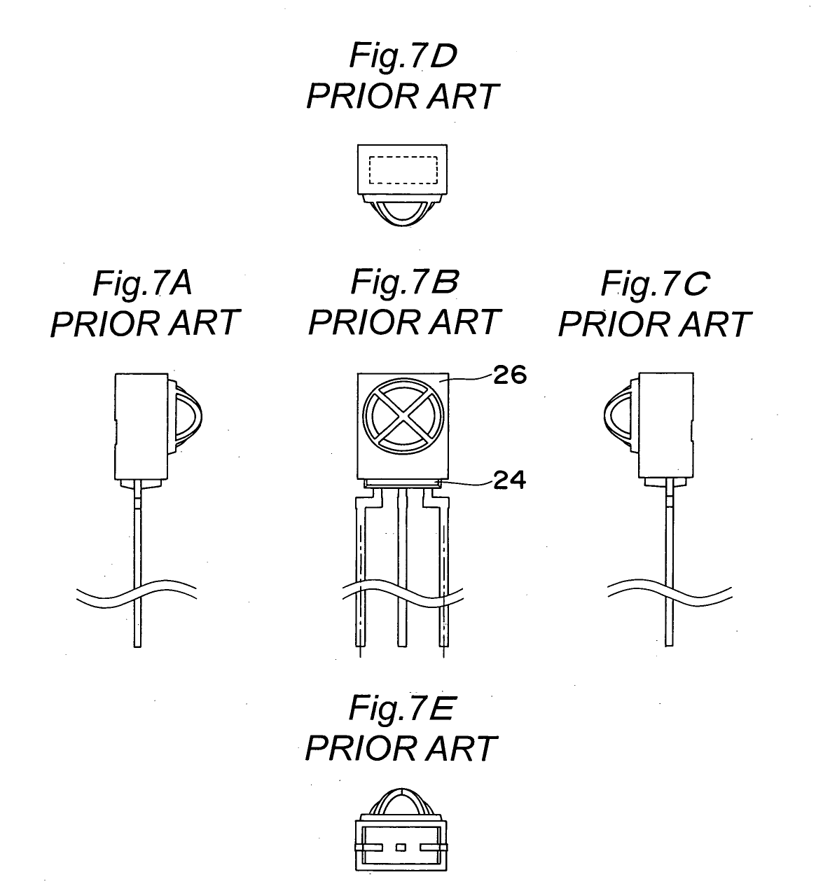

With regards to the remote control photodetection unit 50, a PD chip 17 and a preamplifier IC chip 19 are die bonded to a lead frame 16 roughly similarly to the practice shown in FIG. 5. After a wire bonding step, they are sealed with a thermosetting resin 24 that transmits infrared rays and cuts off visible light similarly to the practice shown in FIG. 6. Subsequently, a soldering step and a single product cutting step are carried out, completing a single remote control photodetection unit. The structure of the lead terminals described as follows with reference to FIGS. 1A through 1C is formed by angled bending (by a press working method) of the lead frame inserted after the tie bar cutting step of the lead frame. The lead frame, i.e., each lead terminal is made of a metal plate and has elasticity.

The remote control photodetection unit 50 has a mold portion 9 as the component main body, and a plurality of lead terminals, which are a power supply terminal (Vcc) 11, an output terminal (Vout) 7 and a grounding terminal (GND) 10 in this example, are led out downwardly (−Z direction) from the bottom surface of the mold portion 9. In this case, the power supply terminal (Vcc) 11 located at the center is inclined from a lead terminal leadout portion (root) of the electronic component mold portion 9 toward a back surface 1 side (−X direction side). On the contrary, the output terminal (Vout) 7 and the grounding terminal (GND) 10 located at both ends are inclined from the lead terminal leadout portion of the electronic component mold portion 9 toward the front surface 2 side (+X direction side).

The lead terminals 11, 7 and 10 led out aslant in the back-and-forth directions (±X directions) from the electronic component mold portion 9 have bent portions 41, 40 and 42, respectively, which are further bent in the directions of inclination of the lead terminals with respect to the mold portion 9 partway along lengths thereof. In this example, these bent portions 41, 40 and 42 are each processed roughly into a dogleg-like portion that has a starting point 3, an apex 4 and an end point 5.

Portions extending from the starting points 3 to the apexes 4 of the bent portions 41, 40 and 42 are bent so as to more widely astride from the inclination of the upper portion. That is, the bent portion 41 is more largely inclined from the starting point 3 to the apex 4 toward the back surface 1 side (−X direction side), and the bent portions 40 and 42 are more largely inclined from the starting points 3 to the apexes 4 toward the front surface 2 side (+X direction side). Contrariwise, the bent portion 41 is inclined more largely from the apex 4 to the end point 5 toward the front surface 2 side (+X direction side), and the bent portions 40 and 42 are more largely inclined from the apexes 4 to the end points 5 toward the back surface 1 side (−X direction side).

It is noted that the bent portions 41, 40 and 42 can be formed in arbitrary positions along the lengths of the lead terminals 11, 7 and 10 in the lead processing stage. Moreover, the bent portions 41, 40 and 42 may have an approximate bracket-like shape, an approximate U-figured shape or the like besides the approximate dogleg-like shape.

In a case where the lead terminal is made of an iron material of a thickness of 0.4 mm, the bent portion should optimally be designed to a dimensional ratio such that its length L is two with respect to its depth d of one as shown in FIG. 1D (enlarged view of part of the lead terminal 7 in FIG. 1A). If it is attempted to make the ratio of the depth d to the length L greater than one half, the lead is required to be bent at an angle of not smaller than 90°, sometimes causing a trouble of cracks and so on in terms of processing. Moreover, if it is attempted to make the ratio of the depth d to the length L smaller than one half, the angle of bending becomes smaller than 45°, and this results in a design such that the lead easily enters the lead insertion hole 14 (see FIG. 2) of the mount board 31 but easily comes away. Therefore, it is desirable that d/L=½.

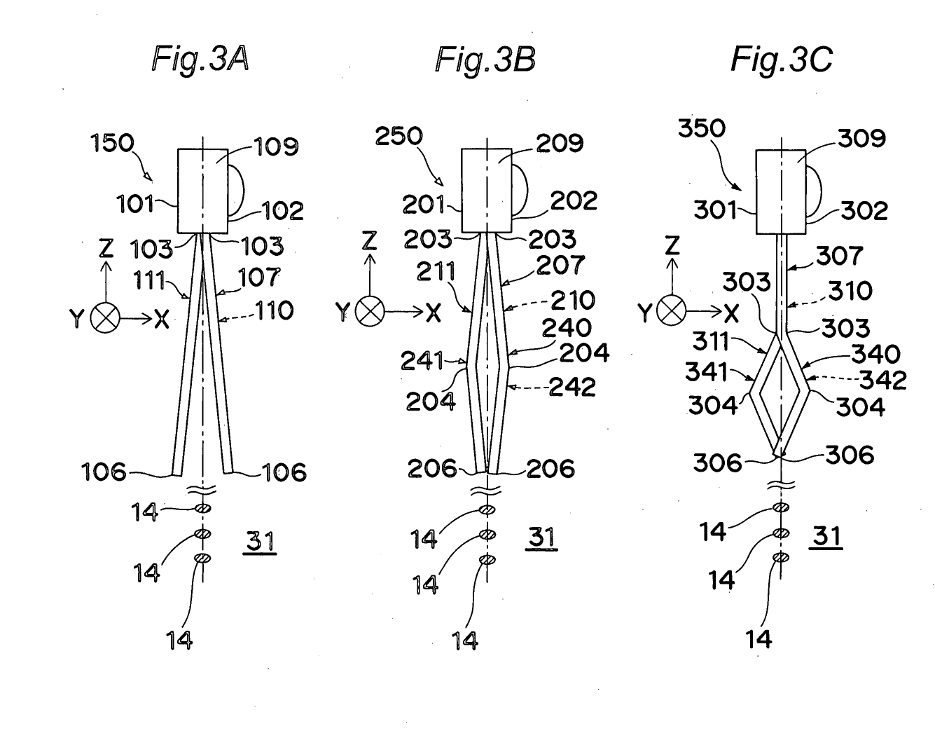

Portions extending from the end points 5 of the bent portions 41, 40 and 42 to lead terminal ends 6 of the lead terminals 11, 7 and 10 are gently inclined so as to come close to the lead insertion holes 14 on the same sides as those of the portions that extend from the apexes 4 to the end points 5 of the bent portions. That is, the lead terminal 11 is gently inclined from the end point 5 to the lead terminal end 6 toward the front surface 2 side (+X direction side), and the lead terminals 7 and 10 are gently inclined from the bent portion end points 5 to the lead terminal ends 6 toward the back surface 1 side (−X direction side). Moreover, the angles of inclination from the bent portion end points 5 are set so that all the lead terminal ends 6 are aligned in a line. This arrangement is intended to facilitate insertion into the lead insertion holes 14 (see FIG. 3A) formed in a line at the mount board 31.

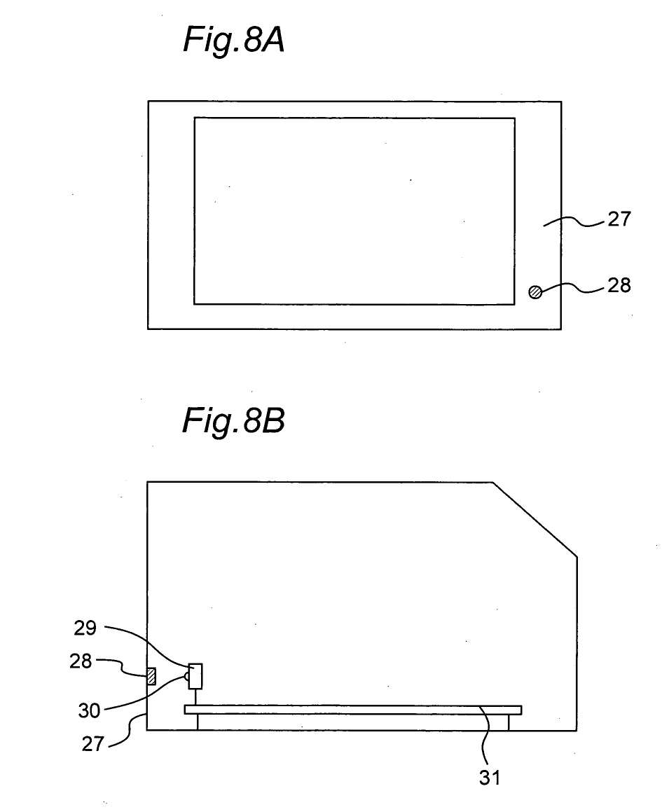

The remote control photodetection unit 50 is intended to be mounted upright on the mount board 31 similarly to the practice shown in FIGS. 8A and 8B. When the remote control photodetection unit 50 is mounted on the mount board 31, the lead terminals 11, 7 and 10 are inserted into the respective corresponding lead insertion holes 14 as shown in FIG. 2. At this time, the portions inclined from the lead terminal ends 6 to the bent portion end points 5 of the lead terminals 11, 7 and 10 are thrust into the lead insertion holes 14. Then, the thrust portion of the lead terminal 11 and the thrust portions of the lead terminals 7 and 10 abut against the inner peripheral edges of the respective lead insertion holes 14 mutually oppositely in the back-and-forth direction, which generates, in the back-and-forth directions (±X directions), spring forces of the lead terminals 11, 7 and 10 that try to regain the original inclination. The remote control photodetection unit 50 stands upright on the mount board 31 due to the operation of the spring force, suppressing the leaning. Therefore, the remote control photodetection unit 50 is stably fixed to the mount board in an upright state by, for example, soldering.

Moreover, since the leads are each bent at an angle close to 45° from the bent portion end point 5 to the bent portion apex 4, the bent portions 41, 40 and 42 operate as a stopper for defining the insertion limiting positions of the lead terminals 11, 7 and 10 with respect to the lead insertion holes 14, so that the bent portion end point 5 and a mount board surface 15 become located at same height positions (see FIG. 2). As a result, the remote control photodetection unit 50 can be mounted in a floating state on the mount board 31.

The positioning in the direction of height of the mount board 31 and the remote control photodetection unit 50 is achieved by arbitrarily setting a distance between the bent portions 41, 40 and 42 and the mold portion 9. That is, by adjusting the distance between the bent portions 41, 40 and 42 and the mold portion 9 when the bent portions 41, 40 and 42 are formed at the lead terminals 11, 7 and 10, the height position of the mold portion 9 from the mount board 31 after the mounting is variably set. With this arrangement, the height position of the mold portion 9 from the mount board 31 can arbitrarily be set.

As shown in FIG. 1E (enlarged view of part of the lead terminal 11 in FIG. 1B), a projection 8 is formed at both ends in the lead terminal width directions (±Y directions) with a length of about 1.6 mm in the direction from the bent portion end point 5 to the lead terminal end 6 on each of the lead terminals 11, 7 and 10. If this arrangement is adopted, when the portions inclined from the lead terminal ends 6 to the bent portion end points 5 of the lead terminals 11, 7 and 10 are thrust into the lead insertion holes 14, the projections 8 and 8 located at both ends in the widthwise directions (±Y directions) abut against the inner peripheral edges of the lead insertion hole 14 in mutually opposite directions with regards to every lead terminals 11, 7 and 10. With this arrangement, the lead terminals 11, 7 and 10 are supported by the inner peripheral edges of the lead insertion holes 14 via the projections 8 and 8 in the transverse directions (±Y directions). Therefore, more stable fixation can be achieved.

Moreover, the projections 8 operate also as a stopper for determining the insertion limiting positions of the lead terminals 11, 7 and 10 with respect to the lead insertion holes 14 similarly to the bent portions 41, 40 and 42.

The projections 8 may be formed in either the initial state of the lead frame (lead frame manufacturing stage) or the lead frame angled bending stage (lead processing stage after a tie bar cutting step). In the former case, a method for locally crushing the lead frame or a method for forming a lead frame shape provided with the projections 8 from the beginning can be adopted. In the latter case, the method of locally crushing the lead frame is adopted.

Moreover, the direction in which the projections 8 are formed may be the direction of thickness of the metal plate that constitutes the lead frame, and the projection 8 may be provided only in one place (provided on only one terminal) with regard to the amount of projections 8 so long as fixation to the mount board can be achieved. As shown in FIG. 1F (enlarged view of part of the lead terminal 11 in FIG. 1C), it is optimal to set the width of the projections 8 in a manner that a cross-sectional dimension constituted of a terminal width 12 including the projections 8 and a terminal thickness 13 becomes slightly larger than the opening dimension of the lead insertion hole 14.

### The Second Embodiment

FIGS. 3A, 3B and 3C show remote control photodetection units 150, 250 and 350 in the natural state of other embodiments viewed from the left side (−Y direction). In FIGS. 3A through 3C, the constituent elements corresponding to the elements shown in FIG. 1A are denoted by reference numerals increased by +100, +200 and +300, respectively.

In the remote control photodetection unit 150 of FIG. 3A, a lead terminal 111 and lead terminals 107 and 110 led out downwardly from a mold portion 109 are processed so as to be inclined in mutually separating directions in the back-and-forth direction (±X directions) from lead terminal leadout portions 103. An end 106 of the lead terminal 111 and ends 106 of the lead terminals 107 and 110 are in a state in which they are spread apart with the inclination kept.

Moreover, in the remote control photodetection unit 250 of FIG. 3B, a lead terminal 211 and lead terminals 207 and 210 led out downwardly from a mold portion 209 are processed to be inclined in mutually separating directions in the back-and-forth directions (±X directions) from lead terminal leadout portions 203, and the directions of inclination are changed at apexes 204 partway so as to come close to each other, so that lead terminal ends 206 are aligned approaching the array of the lead insertion holes 14 on the mount board 31. In this example, the entire lengths of the lead terminals 211, 207 and 210 correspond to bent portions 241, 240 and 242.

Moreover, in the remote control photodetection unit 350 of FIG. 3C, lead terminals 311, 307 and 310 led out downwardly from a mold portion 309 are extended in an identical direction (on an identical YZ plane) partway along lengths thereof, and bent portions 341, 340 and 342 are provided at the terminal ends. In concrete, the lead terminal 311 and the lead terminals 307 and 310 are processed to be inclined in mutually separating directions in the back-and-forth directions (±X directions) at midway bent portion starting points 303 and reversed at bent portion apexes 304 in directions in which they come close to each other, so that lead terminal ends 306 are aligned approaching the array of the lead insertion holes 14 on the mount board 31.

With regard to each of the remote control photodetection units 150, 250 and 350, the lead terminals abut against the inner peripheral edges of the respective insertion holes 14 in mutually opposite directions (±X directions) when the lead terminals are inserted into the respective corresponding lead insertion holes 14, so that the units stand upright with respect to the mount board 31 due to a spring force for restoration of the lead terminals, suppressing the leaning. Therefore, each of the remote control photodetection units 150, 250 and 350 is stably fixed in an upright state to the mount board by, for example, soldering.

### The Third Embodiment

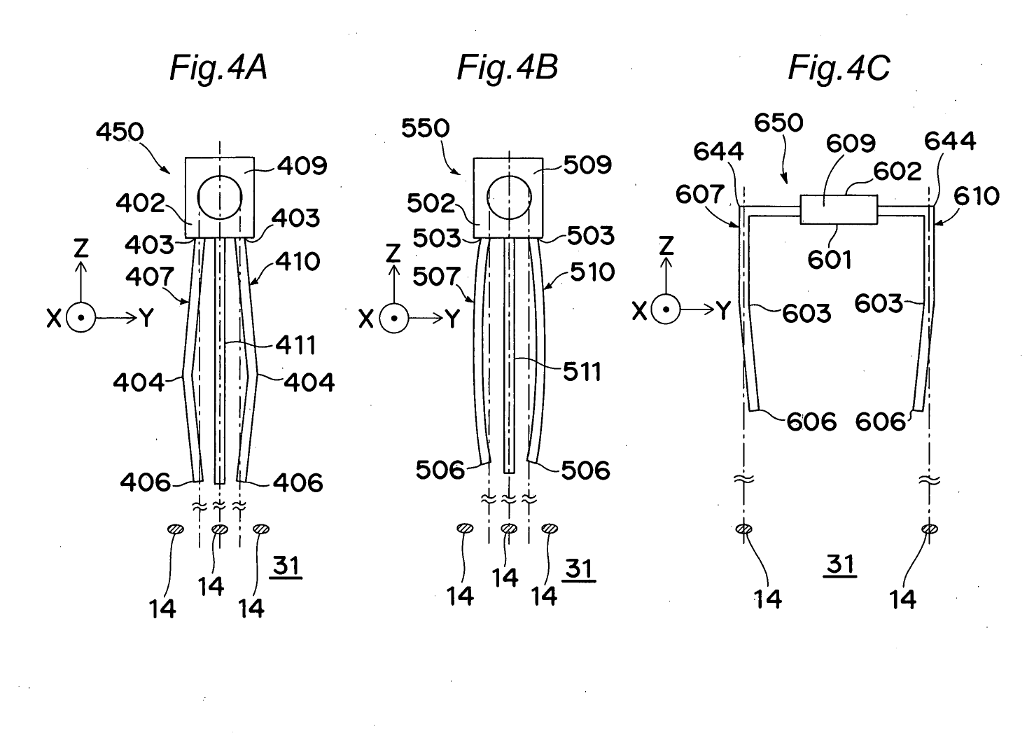

FIGS. 4A, 4B and 4C show remote control photodetection units 450, 550 and 650 in the natural state of other embodiments viewed from the front (+X direction). In FIGS. 4A through 4C, the constituent elements corresponding to the elements shown in FIG. 1B are denoted by reference numerals increased by +400, +500 and +600, respectively.

In the remote control photodetection unit 450 of FIG. 4A, a lead terminal 407 and a lead terminal 410 led out downwardly from a mold portion 409 are processed to be inclined in mutually separating directions in the transverse directions (±Y directions) from a lead terminal leadout portion 403 and have the directions of inclination changed at an apex 404 partway, so that lead terminal ends 406 are aligned approaching the array of the lead insertion holes 14 on the mount board 31. A lead terminal 411 located at the center extends straightly downwardly from the mold portion 409.

Moreover, in the remote control photodetection unit 550 of FIG. 4B, a lead terminal 507 and a lead terminal 510 led out downwardly from a mold portion 509 are processed to be curved drawing arcs in mutually separating directions in the transverse directions (±Y directions) from a lead terminal leadout portion 503, so that lead terminal ends 506 are aligned approaching the array of the lead insertion holes 14 on the mount board 31. A lead terminal 511 located at the center extends straightly downwardly from the mold portion 509.

Moreover, in the remote control photodetection unit 650 of FIG. 4C, a lead terminal 607 and a lead terminal 610, which are led out in the leftward direction (−Y direction) and the rightward direction (+Y direction), respectively, from a mold portion 609 are processed to be bent downwardly (−Z direction) at a bent portion 644 and bent with an inclination in mutually approaching directions in the transverse directions (±Y directions) at a bent portion 603 located downward. An end 606 of the lead terminal 607 and an end 606 of the lead terminal 610 are in a state in which they are put close to each other with the inclination kept.

With regard to each of the remote control photodetection units 450, 550 and 650, the lead terminals abut against the inner peripheral edges of the respective insertion holes 14 mutually oppositely in the transverse directions (±Y directions) when the lead terminals are inserted into the respective corresponding lead insertion holes 14, so that the units stand upright with respect to the mount board 31 by the spring force for restoration of the lead terminals, suppressing the leaning. Therefore, each of the remote control photodetection units 450, 550 and 650 are stably fixed to the mount board in an upright state by, for example, soldering.

The present invention is not limited to the remote control photodetection unit but allowed to be applied to lead terminal leadout type electronic components of a type such that an electronic component is mounted in a floating state on a mount board for anti-noise measures, heat radiation measures and so on caused by interrelations with the components mounted at the periphery of the mount board.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A lead terminal leadout type electronic component comprising:
a component main body; and
a plurality of lead terminals led out of the component main body, wherein
the electronic component is to be mounted on a mount board in a floating state in which the lead terminals are inserted into corresponding insertion holes of the mount board partway along lengths of the lead terminals, respectively, and
at least two lead terminals of the plurality of lead terminals are more largely deformed than opening dimensions of the corresponding insertion holes mutually oppositely in a direction along a surface of the mount board in a natural state so that, when the plurality of lead terminals are inserted into the corresponding insertion holes, the electronic component stands upright with respect to the mount board due to spring forces of said at least two lead terminals which is going to return to the natural state.

2. The lead terminal leadout type electronic component as claimed in claim 1, wherein
deformations of said at least two lead terminals in the natural state are comprised of bent portions which are formed mutually oppositely in a back-and-forth direction partway along lengths of the lead terminals, respectively.

3. The lead terminal leadout type electronic component as claimed in claim 2, wherein
portions located on a terminal end side with respect to the bent portions of said at least two lead terminals are bent with respect to the bent portions so as to approach the corresponding insertion holes.

4. The lead terminal leadout type electronic component as claimed in claim 2, wherein
the bent portions have an approximate dogleg-like shape, an approximate bracket-like shape or an approximate U-figured shape.

5. The lead terminal leadout type electronic component as claimed in claim 2, wherein
the bent portions serve as insertion limiting positions of the lead terminals in the insertion holes when the plurality of lead terminals are inserted into the respective corresponding insertion holes.

6. A lead terminal leadout type electronic component mounting method for mounting the lead terminal leadout type electronic component of claim 2 on the mount board in a state in which the lead terminals are inserted in the corresponding insertion holes of the mount board partway along lengths of the lead terminals, respectively, wherein,
by adjusting a distance between the bent portion and the component main body when the bent portion is formed on said at least two lead terminals, a height position of the component main body from the mount board after mounting is variably set.

7. The lead terminal leadout type electronic component as claimed in claim 1, wherein
a portion of a width greater than that of a remaining part of each of the lead terminals is provided partway along the length of the lead terminal, and the portion serve as an insertion limiting position of the lead terminal in the insertion hole.

8. The lead terminal leadout type electronic component as claimed in claim 1, wherein
a portion of a thickness greater than that of a remaining part of each of the lead terminals is provided partway along the length of the lead terminal, and the portion serve as an insertion limiting position of the lead terminal in the insertion hole.

9. Electronic equipment equipped with the lead terminal leadout type electronic component claimed in claim 1.
